(19) United States
(12) Patent Application Publication
(10) Pub. No.: US 2008/0211977 A1
(43) Pub. Date: Sep. 4, 2008

(54) Configurable Multi-View Display Device

(75) Inventors: Willem Lubertus Ijzerman, Eindhoven (NL); Marcellinus Petrus Carolus Michael Krijn, Eindhoven (NL); Siebe Tjerk De Zwart, Eindhoven (NL); Gerardus Petrus Karman, 's-Gravenhage (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,399

(22) PCT Filed: Sep. 25, 2006
(86) PCT No.: PCT/IB06/53464

§ 371 Date: Apr. 7, 2008

(30) Foreign Application Priority Data
Oct. 5, 2005 (EP) 05109236.9

(51) Int. Cl. H04N 13/00; G02F 1/1333

(52) U.S. Cl. 349/15

(57) ABSTRACT

A configurable multi-view display device (100) is disclosed. The multi-view display device (100) comprises: a structure (104) of light modulating elements (105-108) being located in a first plane, which are arranged to provide respective light beams to; optical directory means (110) being located in a second plane which is substantially parallel to the first plane, for directing the respective light beams into one or more predetermined directions relative to the first plane, depending on an actual view configuration of the multi-view display device; and optical configuration means (120) for optically setting the multi-view display device in the actual view configuration, by means of the structure (104) of light modulating elements (105-108).

The invention relates to a configurable multi-view display device, comprising:

a structure of light modulating elements being located in a first plane, which are arranged to provide respective light beams to;

optical directory means being located in a second plane which is substantially parallel to the first plane, for directing the respective light beams into one or more predetermined directions relative to the first plane, depending on an actual view configuration of the multi-view display device.

Since the introduction of display devices, a realistic three-dimensional (3D) display device has been a dream for many years. Many principles that should lead to such a display device have been investigated. Some principles try to create a realistic 3D object in a certain volume. For instance, in the display device as disclosed in the article “Solid-state Multi-planar Volumetric Display”, by A. Sullivan in proceedings of SID'03, 1531-1533, 2003, information is displaced at an array of planes by means of a fast projector. Each plane is a switchable diffuser. If the number of planes is sufficiently high the human brain integrates the picture and observes a realistic 3D object. This principles allows a viewer to look around the object within some extent. In this display device all objects are (semi-)transparent.

Many others try to create a 3D display device based on binocular disparity only. In these systems the left and right eye of the viewer perceive another image and consequently, the viewer perceives a 3D image. An overview of these concepts can be found in the book “Stereo Computer Graphics and Other True 3D Technologies”, by D. F. McAllister (Ed.), Princeton University Press, 1993. A first principle uses shutter glasses in combination with for instance a CRT. If the odd frame is displayed, light is blocked for the left eye and if the even frame is displayed light is blocked for the right eye.

Display devices that show 3D without the need for additional appliances are called auto-stereoscopic display devices.

A first glasses-free display device comprises a barrier to create cones of light aimed at the left and right eye of the viewer. The cones correspond for instance to the odd and even sub-pixel columns. By addressing these columns with the appropriate information, the viewer obtains different images in his left and right eye if he is positioned at the correct spot, and is able to perceive a 3D picture.

A second glasses-free display device comprises an array of lenses to image the light of odd and even sub-pixel columns to the viewer's left and right eye.

The disadvantage of the above mentioned glasses-free display devices is that the viewer has to remain at a fixed position. To guide the viewer, indicators have been proposed to show the viewer that he is at the right position. See for instance United States patent U.S. Pat. No. 5,986,804 where a barrier plate is combined with a red and green led. In case the viewer is well positioned he sees a green light, and a red light otherwise.

To relieve the viewer of sitting at a fixed position, multi-view auto-stereoscopic display devices have been proposed. See for instance United States patents U.S. Pat. No. 6,064,424 and US20000912. In the display devices as disclosed in U.S. Pat. No. 6,064,424 and US20000912 a slanted lenticular is used, whereby the width of the lenticular is larger than two sub-pixels. In this way there are several images next to each other and the viewer has some freedom to move to the left and right.

A drawback of auto-stereoscopic display devices is the resolution loss incorporated with the generation of 3D images. It is advantageous that those display devices are switchable between a (two-dimensional) 2D and 3D mode, i.e. a single-view mode and a multi-view mode. If a relatively high resolution is required, it is possible to switch to the single view mode since that has higher resolution.

An example of such a switchable display device is described in the article “A lightweight compact 2D/3D autostereoscopic LCD backlight for games, monitor and notebook applications” by J. Eichenlaub in proceedings of SPIE 3295, 1998. It is disclosed that a switchable diffuser is used to switch between a 2D and 3D mode. Another example of a switchable auto-stereoscopic display device is described in WO2003015424 where LC based lenses are used to create a switchable lenticular. See also U.S. Pat. No. 6,069,650.

In principle it is possible to switch the entire display device from 2D to 3D and vice versa. Alternatively, only a portion of the display device e.g. corresponding to a window of a graphical application is switched. That switching may be achieved by passive matrix addressing. The drawback is that the number of windows (i.e. portions having a different view mode compared to the rest of the display device) that can be made with a passive matrix scheme is limited. There are also limits related to the shapes of such portions. For example it is difficult to create a large round area that is in two-dimensional view mode while the remainder is in three-dimensional view mode. Besides that, it is not possible to switch from a first view configuration with e.g. nine views to a second view configuration with e.g. eight views.

It is an object of the invention to provide a configurable multi-view display device of the kind described in the opening paragraph, which can be configured in a multiplicity of view configurations.

This object of the invention is achieved in that the configurable multi-view display device comprises optical configuration means for optically setting the multi-view display device in the actual view configuration, by means of the structure of light modulating elements. Because the structure of light modulating elements is applied to configure the multi-view display device, the variety of view configurations is determined by the variety of spatial light patterns, which can be created by the structure of light modulating elements. It will be clear that the number of different spatial light patterns is enormous if the number of light modulating elements is high, as is standard with conventional display devices.

In an embodiment of the configurable multi-view display device according to the invention, the optical directory means comprises a liquid crystal layer. The advantage of a liquid crystal layer is that it relatively easy to manipulate the optical characteristics locally. An effect of manipulated/modulated optical characteristics is the change of optical paths of light beams passing through the liquid crystal layer. Because of that light beams can be directed into required directions. The manipulation of the optical characteristics is preferably based on an electrical signal.

Preferably, the optical configuration means are arranged to apply a selected predetermined spatial pattern of potential differences to the liquid crystal layer, the selected predetermined spatial pattern being selected from a set of predetermined spatial patterns of potential differences, the selected predetermined spatial pattern being related to the actual view configuration. In this embodiment according to the invention the optical characteristics of the liquid crystal layer are adapted by a two-dimensional electrical signal, i.e. the predetermined spatial patterns of potential differences.

There are several ways to apply the two-dimensional electrical signal. In an embodiment the two-dimensional electrical signal is provided by applying a two-dimensional pattern of light to a photoconductive layer which is located parallel to the liquid crystal layer. Alternatively, the two-dimensional electrical signal is provided by applying a two-dimensional pattern of light to an active matrix plate that comprises a number of circuits that are substantially independently controllable. Each of the elements comprises a separate photoconductive element which is controlled by the corresponding light modulating element. The advantage of such an active matrix plate is the accuracy of control of the liquid crystal layer. In other words, more complex structures of lenses can be created.

In an embodiment of the configurable multi-view display device according to the invention, the structure of light modulating elements is arranged to provide a predetermined spatial pattern of light to the optical configuration means in order to have the selected predetermined spatial pattern of potential differences applied to the liquid crystal layer, the predetermined spatial pattern of light being selected from a set of predetermined spatial patterns of light. The pattern of potential differences are caused by local differences in impedance or resistivity in the photoconductive layer. In other words, the impedance of the photoconductive layer as function of spatial location is determined by the predetermined spatial pattern of light being provided by the structure of light modulating elements.

Preferably, the photoconductive layer has a relative high impedance compared to the liquid crystal layer. That means that changes in the impedance of the photoconductive layer have a relatively strong impact on the potential differences.

Preferably, the structure of light modulating elements are part of a standard, i.e. off-the-shelf two-dimensional display device. For instance the two-dimensional display device is any of the set comprising LCD, PDP, CRT and PolyLED.

In an embodiment of the configurable multi-view display device according to the invention, the two-dimensional display device is an LCD having multiple light sources, of which a first one of the light sources is arranged to generate light with a first wavelength for configuration of the optical directory means and of which a second one of the light sources is arranged to generate light with a second wavelength, being different from the first wavelength, for the rendering of an image. A light source may be a backlight. Modifying an off-the-shelf LCD display in such a way that it comprises independently controllable backlights being arranged to generate light rays having mutually different wavelengths is relatively easy. Alternatively, there is only a single backlight having multiple lamps.

These and other aspects of the configurable multi-view display device, according to the invention will become apparent from and will be elucidated with respect to the implementations and embodiments described hereinafter and with reference to the accompanying drawings, wherein:

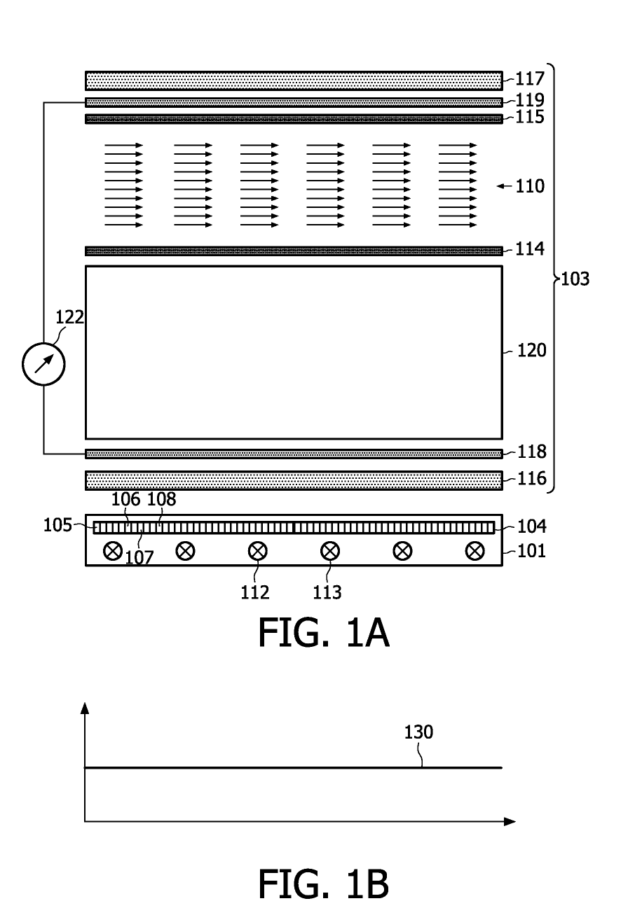

FIG. 1A schematically shows an embodiment of the configurable multi-view display device according to the invention;

FIG. 1B schematically shows a one-dimensional representation of a predetermined spatial pattern of light being applied by the structure of light modulating elements to the optical directory means of the configurable multi-view display device of FIG. 1A;

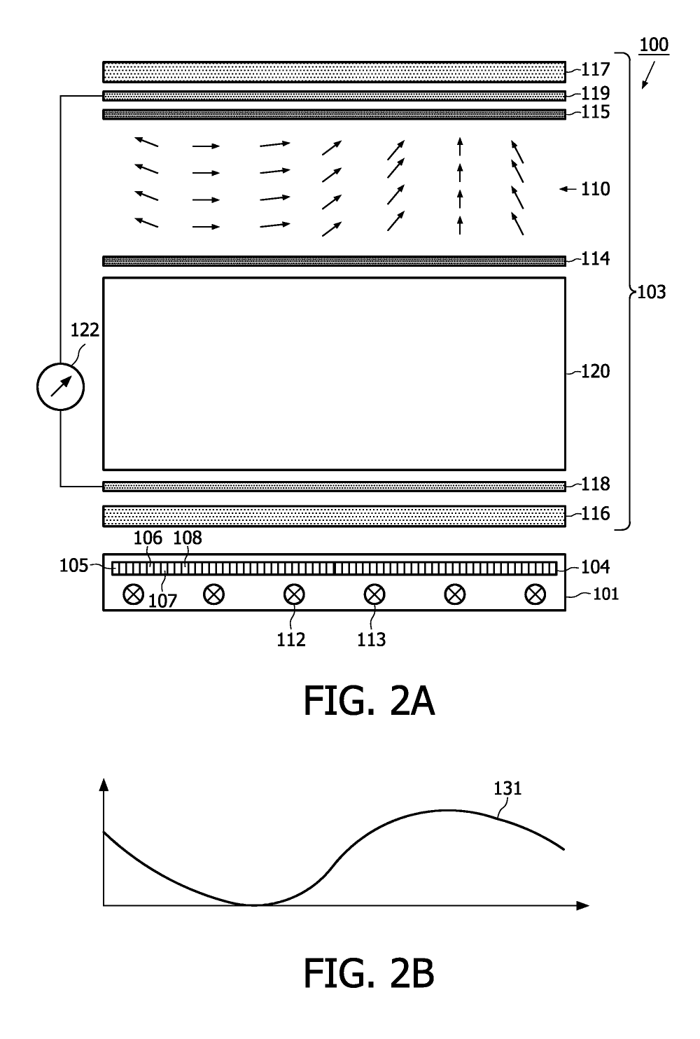

FIG. 2A schematically shows the embodiment of the configurable multi-view display device according to the invention of FIG. 1A whereby an alternative predetermined spatial pattern of light is applied to the optical directory means;

FIG. 2B schematically shows a one-dimensional representation of the predetermined spatial pattern of light being applied by the structure of light modulating elements to the optical directory means of the configurable multi-view display device of FIG. 2A;

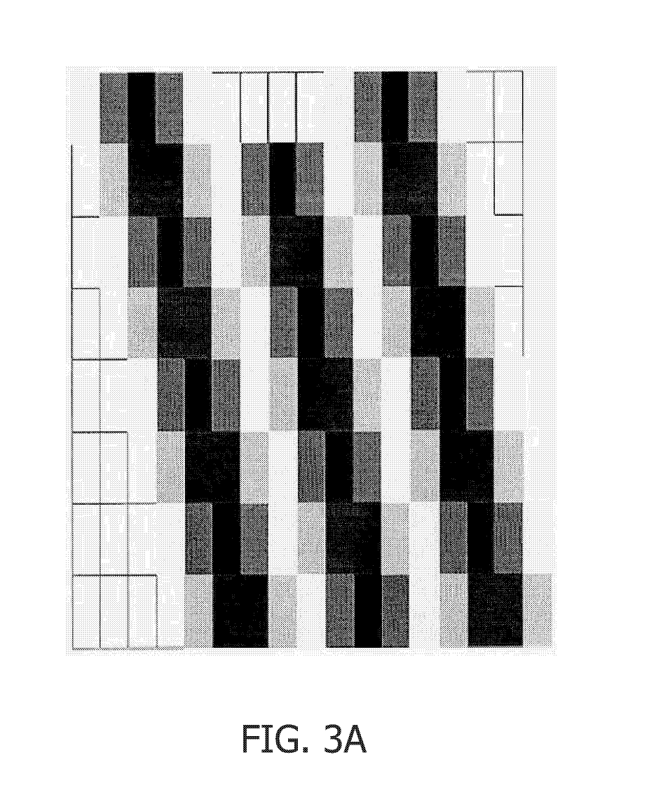

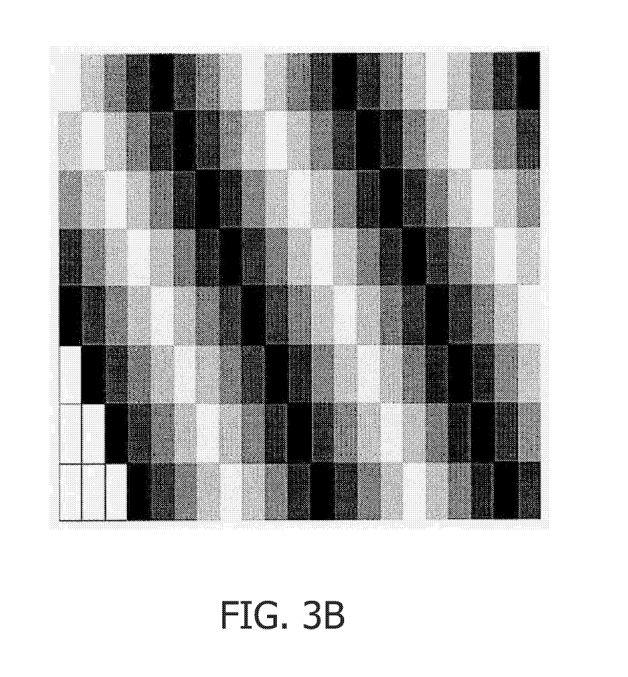

FIG. 3A schematically shows a predetermined spatial pattern of light which can be applied to configure the multi-view display device according to the invention as a nine view display device with a slant angle of ⅙;

FIG. 3B schematically shows an alternative predetermined spatial pattern of light which can be applied to configure the multi-view display device according to the invention as an eight view display device with a slant angle of ⅓;

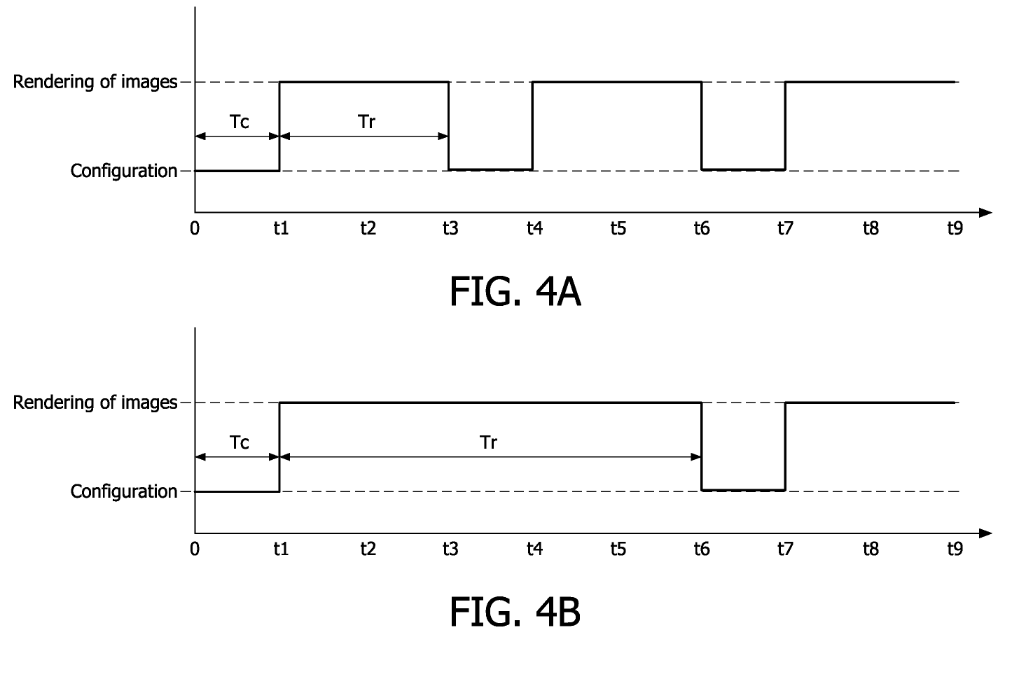

FIG. 4A schematically shows an example of scheduling of tasks of the structure of light modulating elements;

FIG. 4B schematically shows another example of scheduling of tasks of the structure of light modulating elements;

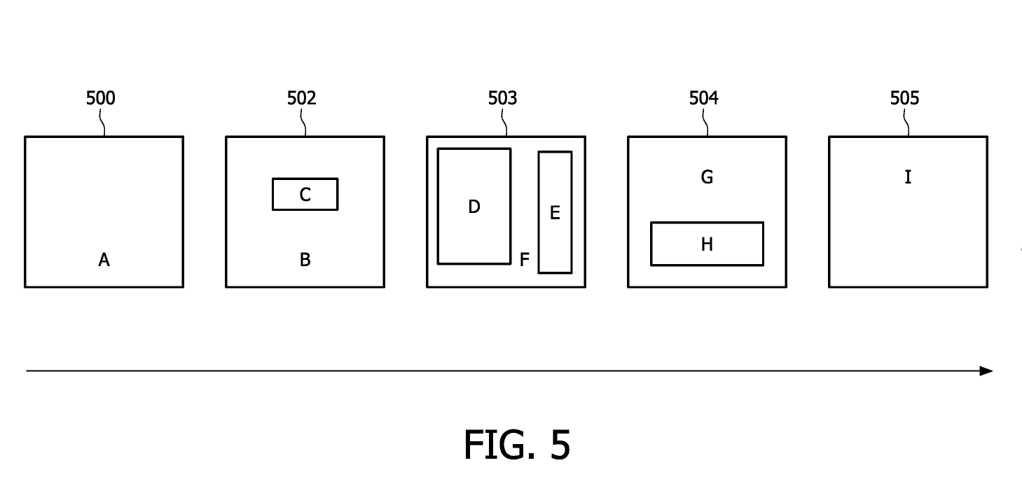

FIG. 5 schematically shows a number of view configurations of the configurable multi-view display device according to the invention as function of time; and

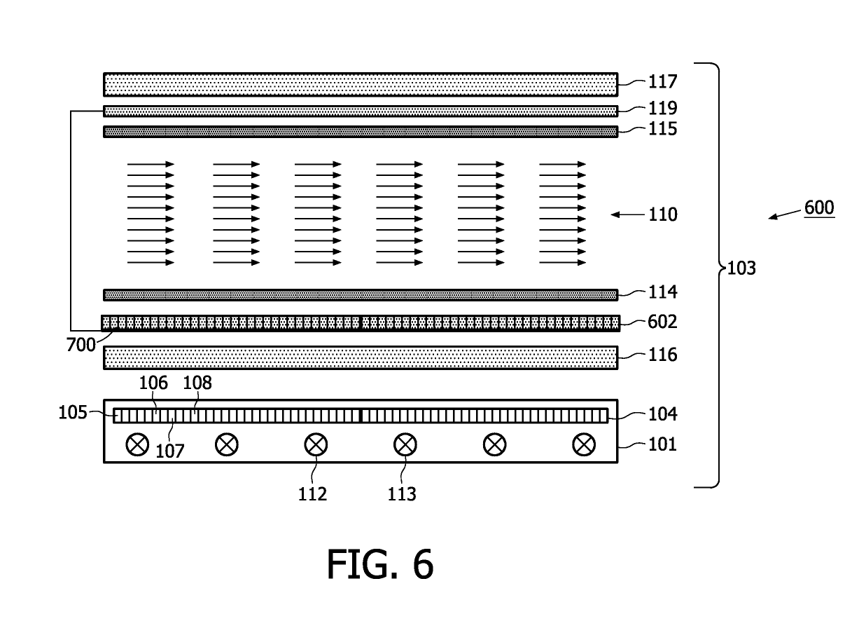

FIG. 6 schematically shows another embodiment of the configurable multi-view display device according to the invention comprising an active matrix plate in which the voltage at each circuit is controlled by a respective photo-conductor; and

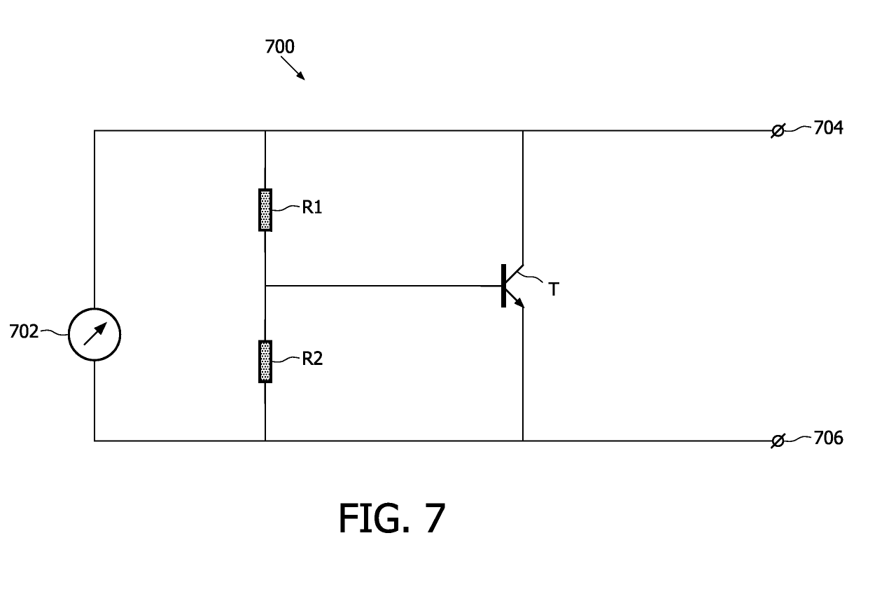

FIG. 7 schematically shows an example of an electronic circuit of an active matrix plate.

FIG. 1A schematically shows an embodiment of the configurable multi-view display device 100 according to the invention, comprising:

a 104 structure of light modulating elements 105-108 being located in a first plane, which are arranged to modulate light being generated by one or more backlights and which are arranged to provide respective light beams to;

optical directory means 110 being located in a second plane which is substantially parallel to the first plane, for directing the respective light beams into one or more predetermined directions relative to the first plane, depending on an actual view configuration of the multi-view display device 100; and

optical configuration means 118-122 for optically setting the multi-view display device in the actual view configuration, by means of the 104 structure of light modulating elements 105-108.

Preferably, the 104 structure of light modulating elements 105-108 is part of an active matrix LCD display device 101, further comprising a set of backlights 112-113 and a polar/retarder (not depicted).

Preferably, the optical directory means and the optical configuration means together form an liquid crystal (LC) cell 103 which comprises:

a set of substantially transparent covers 116-117, e.g. made of glass; a liquid crystal layer 110;

a set of alignment layers 114-115, typically of polymide (PI-layer). Preferably, a first of the alignment layers 114 is rubbed in a direction that corresponds with the output polarization state of the active matrix LCD display device 101. In this way the extra-ordinary index of refraction matches with the polarization state of the active matrix LCD display device 101. The orientation of the second alignment layer 115 can be chosen arbitrarily;

a set of substantially transparent conductive layers 118-119. These conductive layers 118-119 are preferably made of Indium Tin Oxide (ITO); and

a photoconductive layer 120.

The multi-view display device further comprises a power supply 122 for applying a voltage difference between the set of conductive layers 118-119. Preferably this is an alternating voltage. Otherwise the LC material of the liquid crystal layer 110 might charge and the effect of the photoconductive layer 120 might diminish.

To explain the working of the multi-view display device 100 according to the invention, the following concepts are relevant:

The first concept relates to the rendering of images which may be single view or multi-view images. Whether single view or multi-view images are rendered depends on the actual view configuration of the multi-view display device.

The second concept relates to the action of configuration, i.e. putting the multi-view display device and in particular the optical directory means in an actual view configuration.

The rendering of images is based on image data being provided to the LCD display device 101. The image data represents the driving values for the structure 104 of light modulating elements 105-108. That means that the light being generated by means of one or more of the backlights 112 is modulated by the structure 104 of light modulating elements 105-108, resulting into respective light beams. The light beams pass the various layers of the liquid crystal cell 103 in the direction of a viewer (not depicted). Depending on the actual view configuration of the multi-view display device 100, i.e. the distribution of orientations of the liquid crystals in the liquid crystal layer 110, the direction of the light beams is effected.

For instance, if the distribution of orientations of the liquid crystals is such that most liquid crystals are oriented in plane, as depicted in FIG. 1A, the light beams are not redirected by the liquid crystal layer 110 and hence there is no substantial effect.

However, if the distribution of orientations of the liquid crystals is such that they are oriented on basis of a non-homogeneous electrical field, e.g. oriented as depicted in FIG. 2A, the light beams are redirected by the liquid crystal layer 110, i.e. substantially effected. Then, the light beams as modulated by the light modulating elements 105-108 are redirected in mutually different angular directions relative to the first plane. The distribution is such that the liquid crystal layer 110 forms a set of graded index lenses (grin lenses). The optical paths of the light beams that travel through the liquid crystal cell 103 have mutually different lengths. Consequently, there is a lens action. The amount of lens action is controllable by means of the applied electrical field. In that case, the actual view configuration of the multi-view display device is a multi-view view configuration. Each of the mutually different angular directions in which the light beams are directed corresponds to a respective view.

The action of configuration is based on the generation of a selected predetermined spatial pattern of light. The generation of the selected predetermined spatial pattern of light is the result of light generation by one or more of the backlights 113 and the modulation of the generated light by the structure 104 of light modulating elements 105-108. The selected predetermined spatial pattern of light is provided to the photoconductive layer 120, which is substantially sensible for the wavelengths of the light being generated by the one or more of the backlights 113 which are used to configure the multi-view display device. Preferably, the photoconductive layer 120 is substantially not sensible for the wavelengths of the light beams which are generated to render the images. Optionally switchable optical filters are applied to block unwanted light beams passing through the photoconductive layer 120 during certain time slots.

The result of providing a selected predetermined spatial pattern of light to the photoconductive layer 120 is that a predetermined spatial pattern of impedances is created in the photoconductive layer 120. In other words, the impedance or resistivity as function of spatial position in the photoconductive layer 120 is modulated by providing a selected predetermined spatial pattern of light. That means that the structure 104 of light modulating elements 105-108 is used to modulate the impedances as function of spatial position in the photoconductive layer 120.

By applying a voltage between the conductive layers 118-119 a predetermined pattern of potential differences can be applied to the liquid crystal layer 110 which is determined by the applied voltage and the impedance as function of spatial position in the photoconductive layer 120. Notice that the combination of the liquid crystal layer 110 and the photoconductive layer 120 is a voltage divider. More particular the combination can be interpreted as a two-dimensional structure of voltage dividers, which are each independently adjustable by means of respective amounts of light. Typically, e.g. for LC material TL 213 of Merck, light beams that travel through the parts of the liquid crystal cell 103 that corresponds with the photoconductive layer 120 which are illuminated with relatively much light during configuration, have a shorter optical path than other light beams that travel through other parts of the liquid crystal cell 103 which is illuminated with a relatively low amount of light during configuration. For LC material with a negative dielectric anisotropy the path length is longer for light that travels through parts of the cell 103 that corresponds with the photoconductive layer 120 which are illuminated with relatively much light during configuration. FIG. 1B schematically shows a one-dimensional representation of a predetermined spatial pattern 130 of light being applied by the structure 104 of light modulating elements 105-108 to the optical directory means of the configurable multi-view display device 100 of FIG. 1A. The depicted predetermined spatial pattern 130 of light is homogeneous. As a result the impedance in the photoconductive layer 120 as function of spatial position is constant. The voltage differences between opposite sides of the liquid crystal layer 110 are all mutually equal. In other words, there are no potential differences between different locations in the plane of the first alignment layer 114.

FIG. 2A schematically shows the embodiment of the configurable multi-view display device according to the invention of FIG. 1A whereby an alternative predetermined spatial pattern of light is applied to the optical directory means. FIG. 2B schematically shows the alternative predetermined spatial pattern of light being applied by the structure of light modulating elements to the optical directory means of the configurable multi-view display device of FIG. 2A. Because of the applied voltage difference between the conductive layers 118-119 and the illumination based on the selected spatial pattern of light the liquid crystal molecules reorient themselves as denoted in FIG. 2A.

FIG. 3A schematically shows a predetermined spatial pattern of light which can be applied to configure the multi-view display device according to the invention as a nine view display device with a slant angle of ⅙. With slant angle is meant the angle between the optical axes of the lenses relative to the axis of the structure 104 of light modulating elements 105-108. In United States patent U.S. Pat. No. 6,064,424 is disclosed what the advantage is of a slant angle. That patent discloses a multi-view display device with a fixed view configuration of nine views.

FIG. 3B schematically shows an alternative predetermined spatial pattern of light which can be applied to configure the multi-view display device according to the invention as an eight view display device with a slant angle of ⅓.

The predetermined spatial patterns of light as depicted in FIG. 3A and FIG. 3B are just examples. It will be clear that alternative predetermined spatial patterns of light and corresponding view configurations of the multi-view display device according to the invention are possible. Basically any view configuration can be made, i.e. any type of graded index lenses configuration can be achieved by appropriate illumination of the photoconductive layer 120. That means that determined by the resolution of the structure 104 of light modulating elements 105-108 the following parameter of the multi-view display device can be controlled:

the width of the lenses;

the length of the lenses;

the optical foci of the lenses;

the slant angle of the lenses; and

the position of the lenses.

Notice that, the lenses may extend from a first end of the multi-view display device to be opposite side of the multi-view display device. Alternatively, the lenses form a two-dimensional lenslet array, comprising lenses of which the width and length are substantially mutually equal.

Because of the flexibility it is also possible to configure multiple regions of the multi-view display device being mutually different in view configuration. For instance a first region being configured as a single view region and a second region being configured as a nine-view region. That means that the multi-view display device according to the invention is arranged to mix different types of three-dimensional data and two-dimensional data in a single picture. The shapes of the different regions can be chosen substantially arbitrary. The actual shape of the regions is determined by the resolution of the structure 104 of light modulating elements 105-108.

FIG. 4A schematically shows an example of scheduling of tasks of the structure 104 of light modulating elements 105-108. The horizontal axis corresponds to time. The vertical axis indicates the types of tasks. As said, the structure 104 of light modulating elements 105-108 are used for different purposes/tasks:

configuration of the optical directory means by applying a selected predetermined spatial pattern of light to the photoconductive layer 120; and

rendering of images by modulating light beams and subsequently providing the modulated light beams to the optical directory means which on their turn are arranged to direct the light beams in the required directions.

Typically, configuration and rendering does not take place simultaneously. That means that there are timeslots during which the structure 104 of light modulating elements 105-108 is used for configuration which are alternated by timeslots during which the structure 104 of light modulating elements 105-108 is used for the rendering of images.

Basically, there is no structural difference in operation of the structure 104 of light modulating elements 105-108, during configuration and rendering. That means in both cases/phases a pixel matrix of driving values is provided to the structure 104 of light modulating elements 105-108. However, typically the driving values being provided during the distinct phases are mutually different. During configuration a configuration pixel matrix PMC(i) is provided, with i being an index and during rendering a rendering pixel matrix PMR(i) is provided. The tables below provide some examples of provided pixel matrices. See FIG. 4A.

| | | | | | | | | | |
|---|---|---|---|---|---|---|---|---|---|
| Time | [0, t1> | [t1, t2> | [t2, t3> | [t3, t4> | [t4, t5> | [t5, t6> | [t6, t7> | [t7, t8> | [t8, t9> |
| interval | | | | | | | | | |
| Provided | PMC(1) | PMR | PMR | PMC(1) | PMR | PMR | PMC(1) | PMR | PMR |
| pixel | | (1) | (2) | | (3) | (4) | | (5) | (6) |
| matrix | | | | | | | | | |

### See FIG. 4B

| | | | | | | | | | |
|---|---|---|---|---|---|---|---|---|---|
| Time | [0, t1> | [t1, t2> | [t2, t3> | [t3, t4> | [t4, t5> | [t5, t6> | [t6, t7> | [t7, t8> | [t8, t9> |
| interval | | | | | | | | | |
| Provided | PMC(1) | PMR | PMR | PMR | PMR | PMR | PMC(2) | PMR | PMR |
| pixel | | (1) | (2) | (3) | (4) | (5) | | (6) | (7) |
| matrix | | | | | | | | | |

In FIG. 4A is depicted that the period of configuration Tc is shorter than the period of rendering Tr. However that is not a necessity. The time interval between two successive writings of the predetermined spatial patterns of light, i.e. the maximum length of the period of rendering Tr depends on the relaxation time of the LC material. If the LC material is viscous, a refresh is not necessary for a relatively long period.

To avoid the user to see/observe the illumination pattern, i.e. the selected predetermined spatial pattern of light, there are several possible ways to operate the multi-view display device. Firstly, Tc could be chosen sufficiently small, in particular relative to Tr. In that case only a small amount of time the illumination pattern is actually visible, but if sufficiently short not really noticeable.

Secondly, it is possible to use light having a particular wavelength or range of wavelengths to illuminate the photoconductive layer 120. The light having this particular wavelength can be invisible or blocked by a color (interference) filter. Due to the color filter the viewer is also not able to see the illumination pattern. In addition, ambient light cannot activate the photoconductive layer 120 and hence it cannot create a spurious lens action.

Notice that a single view configuration of a particular region can be created by either full illumination of the particular region or by no illumination of the particular region. In both cases, no spatial pattern of potential differences is created in the photoconductive layer 120, and hence no reorientation of the liquid crystal material is achieved. That means that no lens action is created and consequently no light beams are deflected by the optical directory means.

FIG. 5 schematically shows a number of view configurations of a single embodiment of the configurable multi-view display device 100 according to the invention as function of time:

The first view configuration 500 has one single area A which is in a single view mode, i.e. 2D view mode;

The second view configuration 502 has a first area B which is in a single view mode and a second area C which is in a nine view mode;

The third view configuration 503 has a first area D which is in a single view mode, a second area E which is in a nine view mode and a third area F which is in a 5 view mode;

The fourth view configuration 504 has a first area G which is in a nine view mode with slant angle ⅙ and a second area H which is in a nine view mode with slant angle ⅓; and

The fifth view configuration 505 has one single area I which is in a single view mode, i.e. 2D view mode.

Notice that the view configurations as listed above are just examples. They are given to illustrate the flexibility of view configuration of an embodiment of the configurable multi-view display device according to the invention.

FIG. 6 schematically shows another embodiment of the configurable multi-view display device 600 according to the invention comprising an active matrix plate 602. The active matrix plate 602 comprises a number of independently controllable elements 700. Each of the elements 700 comprises an electronic circuit. FIG. 7 schematically shows an example of an electronic circuit of such an active matrix plate element.

The operation of the embodiment of the configurable multi-view display device 600 corresponds to what is described above in connection with FIGS. 3-5. The structure of this embodiment of the configurable multi-view display device 600 is substantially equal to the embodiment of the configurable multi-view display device 100 which is described in connection with FIG. 1-2. The difference is that, instead of a single photoconductive layer 120, this alternative embodiment 600 comprises an active matrix plate 602. The active matrix plate allows controlling the different circuits substantially mutually independent. Each of the circuits has its own photo conductor R1.

In this embodiment of the configurable multi-view display device 600 according to the invention, the voltage across the liquid crystal layer 110 that generates the lens effect is controlled by an optically addressed active matrix plate 602. An example of an optically addressed active matrix plate 602 is described in WO2004072940. The active matrix plate 602 is divided into multiple elements and the electric potential of each element is controlled by the light that is collected by a photo-resistor R1 in the addressing phase, i.e. during configuration.

FIG. 7 shows an embodiment on an electrical circuit of an element 700 of the active matrix plate 602. The electrical circuit comprises:

an active electronic element, preferably a transistor T; and

a voltage divider being connected to the control gate, i.e. base, of the active electronic element. The voltage divider comprises a series of resistors R1, R2, whereby one of the resistors is a photo-resistor R1.

The actual impedance of the photo-resistor R1 is determined by the amount of light that is received by the photo-resistor R1 during a period of configuration Tc. In combination with the voltage that is applied to the voltage divider, i.e. the series of resistors R1, R2, by means of a power supply 702, the actual impedance of the photo-resistor R1 determines the actual voltage that is provided at the control gate of the active electronic element T. The actual voltage that is provided at the control gate determines the actual voltage across the active electronic element T, i.e. between the first and second connector 704 and 706. Preferably, the second connector 706 is connected to a first one of the conductive layers 119. The second connector 704 is located in the plane of active matrix plate 602. That means that the actual voltage across the active electronic element T determines the local voltage across the liquid crystal layer 110.

Typically the operation is as follows. If there is no light received by the photo-resistor R1 in the period of configuration Tc, the resistivity of the photo-resistor R1 is relatively high and the transistor T is closed, and the local voltage across the liquid crystal layer 110 is equal to the driving voltage of the power supply 702. If there is light being received by the photo-resistor R1 in the period of configuration Tc, the resistivity of the photo-resistor R1 is lower and the transistor T is (partly) open. Then the local voltage across the liquid crystal layer 110 is lower.

Instead of optically setting a multi-view display device in the actual view configuration, by means of the structure of light modulating elements, alternative ways of setting a multi-view display device in an actual view configuration are possible. One could think about an electronically controlled active matrix, i.e. an active matrix that is directly controlled by means of an electric signal instead of a predetermined pattern of light. Then the advantages of using the structure of light modulating elements would be missed. A particular advantage is the fact that spatial alignment between optical directory means and light modulating elements is achieved. This is because the structure of light modulating elements is actually used to position the optical directory means.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware or software. The usage of the words first, second and third, etcetera do not indicate any ordering. These words are to be interpreted as names.

1. A configurable multi-view display device, comprising:
light modulating elements located in a first plane for providing respective light beams;
optical directory means located in a second plane which is substantially parallel to the first plane, for directing the respective light beams into one or more predetermined directions relative to the first plane, depending on an actual view configuration of the multi-view display device; and
optical configuration means for optically setting the multi-view display device in the actual view configuration using the light modulating elements.

2. The configurable multi-view display device according to claim 1, wherein the optical directory means comprises a liquid crystal layer.

3. The configurable multi-view display device according to claim 2, wherein the optical configuration means is arranged to apply a predetermined spatial pattern of potential differences to the liquid crystal layer the predetermined spatial pattern being related to the actual view configuration.

4. The configurable multi-view display device according to claim 3, wherein the light modulating elements provide a predetermined spatial pattern of light to the optical configuration means in order to have the selected predetermined spatial pattern of potential differences applied to the liquid crystal layer, the predetermined spatial pattern of light being selected from a set of predetermined spatial patterns of light.

5. The configurable multi-view display device according to claim 3, wherein the optical configuration means comprises a photoconductive layer located parallel to the liquid crystal layer.

6. The configurable multi-view display device according to claim 5, wherein an impedance as function of spatial location of the photoconductive layer is determined by the predetermined spatial pattern of light provided by the light modulating elements.

7. The configurable multi-view display device according to claim 5, wherein the photoconductive layer has a high impedance compared to the liquid crystal layer.

8. The configurable multi-view display device according to claim 3, wherein the optical configuration means comprises an active matrix plate that comprises a number of photoconductive elements which are substantially independently controllable.

9. A configurable multi-view display device (100) according to claim 1, wherein the light modulating elements are part of a two-dimensional display device.

10. The configurable multi-view display device according to claim 8, wherein the two-dimensional display device is selected from a set comprising LCD, PDP, CRT and PolyLED.

11. The configurable multi-view display device according to claim 8, wherein the two-dimensional display device a LCD having multiple light sources, a first of the light sources being arranged to generate light with a first wavelength for configuration of the optical directory means and a second of the light sources being arranged to generate light with a second wavelength, different from the first wavelength, for rendering an image.
